(19) United States
(12) Patent Application Publication
(10) Pub. No.: US 2026/0208358 A1
(43) Pub. Date: Jul. 23, 2026

(54) METHOD AND APPARATUS FOR COLLISION AVOIDANCE FOR A KINEMATIC STRUCTURE, AND ROBOTIC SYSTEM

(71) Applicant: Sony Group Corporation, Tokyo (JP)

(72) Inventors: Sina MIRRAZAVI, Morges (CH); Yannik NAGEL, Zurich (CH)

(21) Appl. No.: 19/137,706

(22) PCT Filed: Dec. 15, 2023
(86) PCT No.: PCT/EP2023/086183

§ 371 Date: Jun. 11, 2025

(30) Foreign Application Priority Data
Dec. 22, 2022 (EP) 22215821

(51) Int. Cl. B25J 9/16; B25J 9/06

(52) U.S. Cl. CPC B25J 9/1666; B25J 9/06

(57) ABSTRACT

Provided is a method of collision avoidance for a kinematic structure. The method comprises receiving pose data indicating a desired pose for the kinematic structure and time data indicating an update interval used to control the kinematic structure. Further, the method comprises performing a constrained optimization process on inverse kinematics of the desired pose in accordance with the time data to obtain for the respective update interval one or more kinematic chain parameters for a collision-free state of the kinematic structure. In addition, the method comprises generating control data for controlling the kinematic structure based on the one or more kinematic chain parameters.

### FIELD

The present disclosure relates to collision avoidance for a kinematic structure. In particular, examples of the present disclosure relate to a method and apparatus for collision avoidance for a kinematic structure, a robotic system, a non-transitory machine-readable medium, and a program.

### BACKGROUND

Kinematic structures, such as robots, computer-animated characters, etc., may be applied to a dynamic environment with stationary and dynamic objects and/or to perform time-varying and unpredictable tasks. To ensure free operation and/or safety of the kinematic structure in such applications, collisions, i.e. unintentional contacts, should be avoided. For collision avoidance, it is conceivable, to find a trajectory of the kinematic structure that is globally connecting a starting configuration of the kinematic structure with a final target configuration in a collision-free way. However, practice has shown that such planning of a trajectory requires high computational effort, rendering this trajectory planning approach non-suitable for dynamic environments and/or time-critical applications.

Hence, there may be a demand for improving collision avoidance of a kinematic structure.

### SUMMARY

This demand is met by a method of collision avoidance for a kinematic structure, an apparatus for controlling a kinematic structure, a robotic system, a non-transitory machine-readable medium, and a program in accordance with the independent claims. Advantageous embodiments are defined in the dependent claims.

According to a first aspect, the present disclosure provides a method of collision avoidance for a kinematic structure. The method comprises receiving pose data indicating a desired pose for the kinematic structure and time data indicating an update interval used to control the kinematic structure. Further, the method comprises performing a constrained optimization process on inverse kinematics of the desired pose in accordance with the time data to obtain for the respective update interval one or more kinematic chain parameters for a collision-free state of the kinematic structure. In addition, the method comprises generating control data for controlling the kinematic structure based on the one or more kinematic chain parameters.

According to a second aspect, the present disclosure provides an apparatus for collision avoidance for a kinematic structure. The apparatus comprises an interface circuitry configured to receive pose data indicating a desired pose for the kinematic structure and time data indicating an update interval used to control the kinematic structure. Further, the apparatus comprises a processing circuitry configured to perform a constrained optimization process on inverse kinematics of the desired pose in accordance with the time data to obtain for the respective update interval one or more kinematic chain parameters for a collision-free state of the kinematic structure. In addition, the processing circuitry is configured to generate control data for controlling the kinematic structure based on the one or more kinematic chain parameters.

According to a third aspect, the present disclosure provides a system comprising an apparatus according to the second aspect, and a robotic device configured to operate based on the control data.

According to a fourth aspect, the present disclosure provides a non-transitory machine-readable medium having stored thereon a program having a program code for performing the method according to the first aspect, when the program may be executed on a processor or a programmable hardware.

According to a fifth aspect, the present disclosure provides a program having a program code for performing the method according to the first aspect, when the program may be executed on a processor or a programmable hardware.

### BRIEF DESCRIPTION OF THE FIGURES

Some examples of apparatuses and/or methods will be described in the following by way of example only, and with reference to the accompanying figures, in which

FIG. 1 illustrates an exemplary apparatus for collision avoidance of a kinematic structure;

FIG. 2 illustrates an example of self-collision avoidance for a kinematic structure in a system;

FIG. 3 illustrates an example of obstacle-collision avoidance for a kinematic structure in a system;

FIG. 4 illustrates in a graph an exemplary influence of a number of collision links on a number of collision pairs;

FIG. 5 illustrates in a graph an exemplary collision avoidance cost function;

FIG. 6 illustrates an exemplary influence of a number of collision links on a number of collision pairs for obstacle-collision avoidance;

FIG. 7 illustrates in a flowchart an exemplary method of collision avoidance for a kinematic structure.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

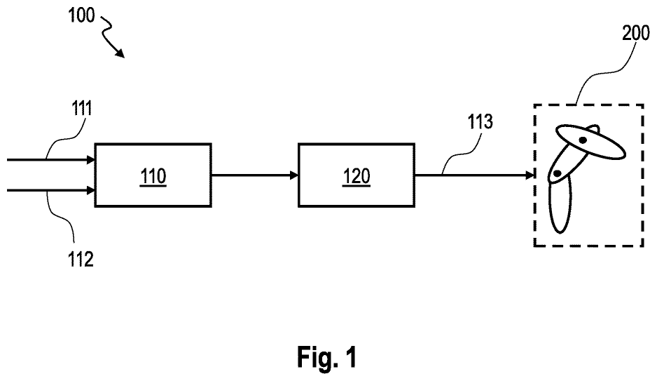

FIG. 1 illustrates an exemplary apparatus 100 for collision avoidance of a kinematic structure 200. The kinematic structure 200 may be any kind of controllable kinematic device or system comprising or being formed of a kinematic chain, such as a robotic device or system, an animated character used in computer animation or gaming, or the like. Thereby, the kinematic structure 200 may be applied to an industrial environment for e.g., production, logistics, or the like, or to a computer-animated or gaming environment. The kinematic chain of the kinematic structure 200 may be configurable, manipulable and/or controllable to provide or effect movement, a pose, etc., of the kinematic structure 200. For example, the kinematic chain may comprise one or more of a link, joint, actuator, manipulator, etc., which may be controlled individually or simultaneously. In some examples, the kinematic chain may at least partly form a computer animation or gaming character's skeleton, or the like, which may be configured, manipulated and/or controlled. However, it is to be noted that the kinematic structure 200 is not limited to the foregoing examples. Generally, the apparatus 100 is configured to determine a collision-free state for the kinematic structure 200, and particularly of a pose thereof, with respect to itself, i.e., for self-collision or joint-collision avoidance, and/or an environment to which the kinematic structure 200 is applied, i.e., for obstacle-collision avoidance. In at least some examples, the apparatus 100 is configured to control the kinematic structure 200 in accordance with the determined collision-free state.

The apparatus 100 comprises at least interface circuitry 110 and processing circuitry 120. The processing circuitry 120 is operatively connected to the interface circuitry 110. The interface circuitry 110 is configured to receive pose data 111 indicating a desired pose for the kinematic structure 200 and time data 112 indicating an update interval used to control the kinematic structure 200. The pose data 111 may be received from any suitable data source, such as a controller, or the like, of which the apparatus 100 may be a part, which may be a part of the apparatus 100, or which forms with the apparatus 100 a system, such as robotic system, etc. As used herein, the pose may be understood as representing a position and orientation of the kinematic chain 200 in preferably three dimensions or in space. The pose may be in accordance with or may be configured to address a task to be performed by the kinematic structure 200. For example, the task to be performed may include any kind of movement in the environment or space, interaction with or manipulation of another object, such as a tool, a production material, another computer animated character, etc., wherein neither the pose nor the task is limited herein, and/or any other kinematic action. The update interval, as used herein, may be received from any type of timer configured to indicate a system time. The update interval may also be referred to as a computation interval, a time step, a system frequency, or the like. For instance, the update interval may be a computation interval, a frequency, or the like, with which the kinematic structure 200 and/or a system to which the kinematic structure 200 is applied to, such as a robotic system, a computer animation or gaming environment, or the like, is updated, e.g., operated, controlled, etc. Optionally, the interface circuitry 110 may be configured to receive further input data. For example, the interface circuitry 110 may be configured to receive one or more of information about the environment of the kinematic structure 200, a current state of the kinematic structure 200 and a current state of one or more obstacles related to the kinematic structure 200. Such information may be obtained from one or more sensors or the like.

The processing circuitry 120 is configured to receive and process the pose data 111 and the time data 112. Further, the processing circuitry 120 may be configured to receive and process information about the environment of the kinematic structure 200, a current state of the kinematic structure 200 and a current state of one or more obstacles related to the kinematic structure 200 to determine, for example, a relative velocity between the kinematic structure 200 and one or more obstacles, or other environment-related information. For instance, the processing circuitry 120 may be a single dedicated processor, a single shared processor, or a plurality of individual processors, some of which or all of which may be shared, a digital signal processor (DSP) hardware, an application specific integrated circuit (ASIC), a neuromorphic processor or a field programmable gate array (FPGA). The processing circuitry 120 may optionally be operatively connected to, e.g., read only memory (ROM) for storing software, random access memory (RAM) and/or non-volatile memory. Optionally, the processing circuitry 120 may be operatively connected to a network controller to communicate via a network in order to remotely control the kinematic structure 200. Further optionally, the apparatus 100 may comprise further circuitry.

In particular, the processing circuitry 120 is configured to perform a constrained optimization process on inverse kinematics of the desired pose, which is obtained based on or determined from the pose data 111, in accordance with the time data 112 to obtain for the respective update interval one or more kinematic chain parameters for a collision-free state of the kinematic structure 200. For this, the processing circuitry 120 may comprise or utilize a solver that is coupled to the update interval. Further below, with respect to the equations used, the update interval is denoted by Δt.

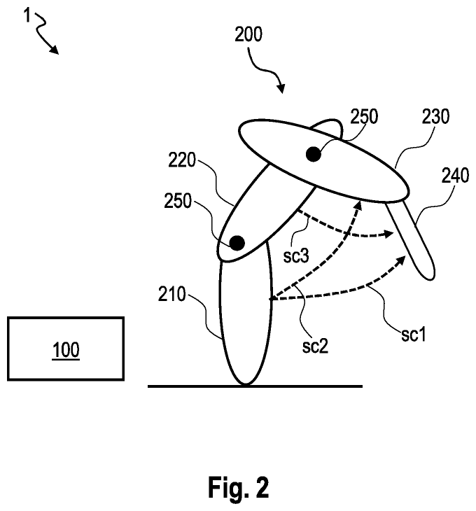

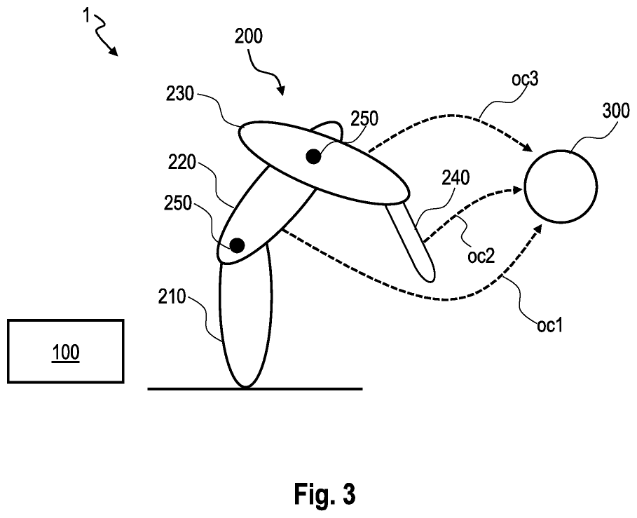

As used herein, the collision-free state of the kinematic structure 200 may refer to any state or configuration of the kinematic structure 200 in which a minimum distance is maintained between elements within the kinematic chain to each other, also referred to as self-collision avoidance and/or joint-collision avoidance, and/or between the kinematic structure 200 or the elements of its kinematic chain and one or more obstacles, i.e., another static or dynamic object in the environment, also referred to as obstacle-collision avoidance, in order to avoid unintentional contact. The one or more kinematic chain parameters may refer to any parameter related to controlling the kinematic chain that can be determined and set on a collision avoidance measure, in particular motion. For example, in the case of a robotic device (see e.g., FIG. 2 and FIG. 3), the one or more kinematic chain parameters may refer to e.g., a joint, an actuator, or the like. Also, in case of a robotic device, the kinematic chain may comprise one or more links, joints, or the like, which may be operated via one or more actuators.

Further, as used herein, the inverse kinematics may be understood as a computational process of determining, calculating, or the like, one or more variable kinematic chain parameters configured to place one or more elements of the kinematic chain, such as a link, a joint, a manipulator, an animation or a gaming character's skeleton, in a given position and orientation, i.e., a pose, relative to a start of the kinematic chain. In case of a robotic device, the start of the kinematic chain may be a base of the robotic device.

The optimization process, as used herein, may be understood as a computational process of determining, e.g., finding, a preferred, e.g., the best, etc., or generally an optimized, solution from a set of feasible alternatives for the collision-free state of the kinematic structure 200. For example, the problem underlying the optimization process may be formulated according to the following mathematical expression:

$$min \frac{1}{2} {x}^{T} Px + {q}^{T} x \qquad ( Eq . 1 )$$

$$subject to Gx \leq h$$

$$Ax = b$$

$${x}_{min} \leq x \leq {x}_{max}$$

$$with x = \dot{q} ,$$

with P denoting a matrix representing one or more objectives, q^{T} denoting a vector representing one or more objectives, G denoting a(n) (inequality) constraint matrix, h denoting a(n) (inequality) constraint vector, A denoting a(n) (equality) constraint matrix, b denoting a(n) (equality) constraint vector and \dot{q} denoting a joint velocity. Accordingly, the problem is formulated as a convex optimization exclusively utilizing convex cost functions and constraints, resulting in fast computation. In at least some examples, the optimization process on the inverse kinematics utilizes quadratic programming, utilizing quadratic and linear cost functions. However, it is to be noted that the present disclosure is not limited to the above example. Any other suitable method for formulating the problem may be utilized as well. In general, the processing circuitry 120 is configured to determine, by performing the optimization process, such kinematic chain parameters and/or states of the kinematic structure 200 not violating the one or more constraints for or associated with the collision-free state to obtain optimized one or more kinematic chain parameters.

Thereby, the inverse kinematics may be solved on the level of joint angle velocities due to the convex relationship between joint angle velocity and spatial velocity of any point on the kinematic structure 200 according to the following mathematical expression:

$$\dot{x} = J ( q ) \dot{q} , \qquad ( Eq . 2 )$$

with \dot{x} denoting a task space velocity, J(q) denoting a Jacobian matrix, and \dot{q} denoting the above joint velocity. However, it is to be noted that the present disclosure is not limited to the above example. Any other suitable method for solving the inverse kinematics can be utilized as well.

For example, the optimization process may comprise defining and/or solving a number of objectives at least for or associated with one or more of self-collision avoidance and/or joint-collision avoidance, and/or obstacle-collision avoidance to obtain optimized one or more kinematic chain parameters for the collision-free state. For instance, the optimization process may utilize a number of, i.e., one or more, cost functions and/or constraints to define and/or solve the number of objectives. By way of example, the number of objectives for the optimization problem underlying the optimization process to be performed by the processing circuitry 120 may be formulated according to the following mathematical expression:

$$P = {P}_{t} + {P}_{acc} \qquad ( Eq . 3 )$$

$${q}^{T} = {q}_{t}^{T} + {q}_{sc}^{T} + {q}_{oc}^{T} + {q}_{acc}^{T}$$

$$G = [ {G}_{sc} {G}_{oc} {G}_{j} {G}_{acc} ]$$

$$h = [ {h}_{sc} {h}_{oc} {h}_{j} {h}_{acc} ] ,$$

wherein each objective may produce an independent matrix Pᵢ and/or an independent vector

$${q}_{i}^{T}$$

and/or an independent matrix. The indices of Pᵢ and

$${q}_{i}^{T}$$

are denoted to mean t: (last link or end effector) tracking, sc: self-collision avoidance and/or joint collision avoidance, oc: obstacle-collision avoidance, acc: acceleration and/or motion smoothness, and j: joint limit(s). These indices or abbreviations for tracking t, self-collision avoidance and/or joint-collision avoidance sc, obstacle-collision avoidance, acceleration or motion smoothness acc and joint limit(s) j are used throughout this disclosure where appropriate. It is noted that for mere collision avoidance, the terms and/or equations denoted by the index sc and/or oc are sufficient, while the further terms and/or equations denoted by t, acc and/or j are optional. The individual output for matrix Pᵢ and vector

$${q}_{i}^{T}$$

may be combined, e.g., added, to create the final P matrix and q^{T} vector of the total optimization problem according to Eq.1. The individual constraint matrices Gᵢ and vectors hᵢ may also be combined, e.g., added or stacked together. Constraining the optimization process, for example, may comprise utilizing one or more constraints separating an admissible, collision-free space of the kinematic structure 200 from a non-collision-free, forbidden space of the kinematic structure 200. This is denoted by the above indices sc, i.e., self-collision avoidance, and oc, i.e., obstacle-collision avoidance, for P₁ and

$${q}_{i}^{T} .$$

Further, one or more constraints may relate to one or more hardware limitations, such as a joint limit, a joint angle limit, a joint velocity limit, a joint acceleration limit, an acceleration limit, a jerk limit, or the like, of the kinematic structure 200. This is denoted by the above index j for Pᵢ and

$${q}_{i}^{T} .$$

In at least some examples, one or more constraints may relate to motion smoothness, considering e.g., an acceleration limit, a jerk limit, or the like, desired for operation the kinematic structure 200. This is denoted by the above index acc for Pᵢ and

$${q}_{i}^{T} .$$

Generally, the one or more constraints may set boundaries within which a full state space is available for determining optimized one or more kinematic chain parameters through the inverse kinematics.

Further, the processing circuitry 120 is configured to generate, based on the determined one or more kinematic chain parameters, control data 113 for controlling the kinematic structure 200. For this, the apparatus 100 may comprise a data interface to the kinematic structure 200 and/or to a related robotic system, a computer animation environment or engine, or a gaming environment or engine, or the like. The control data 113 may be configured to control e.g., motion of the kinematic structure 200 under collision avoidance, e.g., by controlling corresponding actuators, joints, links, etc. of the kinematic structure 200 or animation or gaming engines.

By coupling the optimization-based inverse kinematics to the update interval Δt indicated by the time data 112 to carry out its full computation at each update interval, the kinematic structure 200 may be controlled under collision avoidance for even dynamic tasks and/or in unstructured and unpredictable environments, e.g., with one or more dynamic obstacles (e.g., obstacle 300 in FIG. 2 or FIG. 3). Performing the constrained optimization process may require only little computational effort. Further, by performing the constrained optimization process on the inverse kinematics of the desired pose, the kinematic structure 200 may be controlled, based on the resulting one or more kinematic chain parameters, to operate at its limit considering feasibility.

More detailed examples of the proposed collision avoidance will be given in the following with reference to FIG. 2 and FIG. 3 illustrating a system 1 comprising the above apparatus 100 and an exemplary kinematic structure 200. In these examples, the kinematic structure 200 is formed as a robotic device, comprising a base (not denoted), a first link 210, a second link 220, a third link 230 and an end effector 240, i.e., the last or most distal link from the base of the kinematic structure 200. The kinematic structure 200, i.e., the robotic device, comprises a number of joints 250 connecting neighboring links 210, 220, 230, 240 with each other. It should be noted that although the kinematic structure 200 according to FIGS. 2 and 3 is a sixaxis robotic device, the kinematic structure 200 described herein is not limited thereto, and the proposed collision avoidance may also be applied to a robotic device having another configuration. Further, as described herein, the proposed collision avoidance may also be applied to computer animation or gaming, wherein the kinematic structure 200 may be a computer animated or gaming character, or the like.

It is noted that FIG. 2 and FIG. 3 illustrate the kinematic structure 200 as a collision representation which can optionally be utilized as a simplified representation, model, or the like, of the kinematic structure 200 to minimize the computational effort for collision avoidance. For this, the collision representation of the kinematic structure 200 may comprise a number of bodies from and to which e.g., distances can be computed with little computational effort. Optionally, information about a gradient of a closest distance from or to, and/or between, the bodies may be determined. For instance, the bodies may be provided by one or more model, e.g., 3D models, such as mesh-files, or the like, of the links and/or primitive shapes, allowing an efficient distance computation. By way of example, FIGS. 2 and 3 illustrate a four-body collision representation with each of the links 210, 220, 230, 240 forming one body. However, utilizing the collision representation is not mandatory and FIGS. 2 and 3 only serve to explain the proposed collision avoidance.

FIG. 2 illustrates an exemplary kinematic structure 200 formed as a robotic device, which may be controlled at least partly by the above apparatus 100. In FIG. 2, arrows indicate three link-pair combinations sc1, sc2 and sc3, on the basis of which an example of self-collision avoidance, which may include joint-collision avoidance, for the kinematic structure 200 will be explained in the following.

In general, the processing circuitry 120 is configured, in the optimization process, to penalize closeness of elements, e.g., links, within the kinematic chain of the kinematic structure 200 to each other to obtain optimized one or more kinematic chain parameters. In other words, the processing circuitry 120 may be configured, in the optimization process, to find one or more kinematic chain parameters for a self-collision-free state, which may be comprised by the collision-free state to be determined for the kinematic structure 200.

As used herein, the index sc of matrix Pᵢ and vector

$${q}_{i}^{T}$$

relates to self-collision avoidance. Self-collision may occur between the links 210, 220, 230, 240 resulting in a number of link-pair combinations. Thereby, the processing circuitry 120 may be configured to avoid self-collision between two consecutive of the links 210, 220, 230, 240 by determining and/or setting respective joint limit constraints in the optimization process. For the further link-pair combinations sc1, sc2 and sc3, the optimization problem may comprise a constraint according to the following mathematical expression:

$$\frac{1}{{k}_{sc}} ( d - {d}_{safety} ) \geq - \frac{δ d}{δ q} Δ t \dot{q} , \qquad ( Eq . 4 )$$

with d denoting a current distance, d_{safety} denoting a safety distance, k_{sc} denoting a feasibility scalar for self-collision, Δt denoting the update interval as provided by the time data 112 and \dot{q} denoting a joint velocity. This self-collision avoidance constraint restricts how much the shortest distance between any two links, e.g., links 210, 220, 230, 240 are allowed to change within the update interval Δt. The shortest distance between each link pair may be defined by Points P1 and P2 which are closest to each other for each link pair. The distance travelled within the update interval Δt by applying any joint velocity at the beginning of the update interval Δt is described by the right side of inequality Eq. 4. Restricting this distance to less or equal than the distance itself, be reduced by defining the safety distance d_{safety}, on the left side of the inequality Eq. 4 results in not reaching any distance less than the safety distance d_{safety}. Based on this, the processing circuitry 120 is configured to establish self-collision avoidance. The feasibility of the forgoing self-collision constraint may be provided by the feasibility scalar k_{sc}≥1 defining how fast the distance d is allowed to reach the safety distance d_{safety}, thereby indicating how much joint acceleration is to be applied to comply with this boundary. However, it is to be noted that the present disclosure is not limited to the above example. Any other suitable method for self-collision can be utilized as well. It is noted that the number of further link-pair combinations sc1, sc2 and sc3, which may also be referred to as the number of collision pairs, may be determined, for example, by the mathematical expression

$${n}_{P} = {\sum }_{i = 2}^{i = {n}_{L}} {n}_{L} - i ,$$

with n_{P} denoting the number of collision pairs and n_{L} denoting the number of links of the kinematic structure 200.

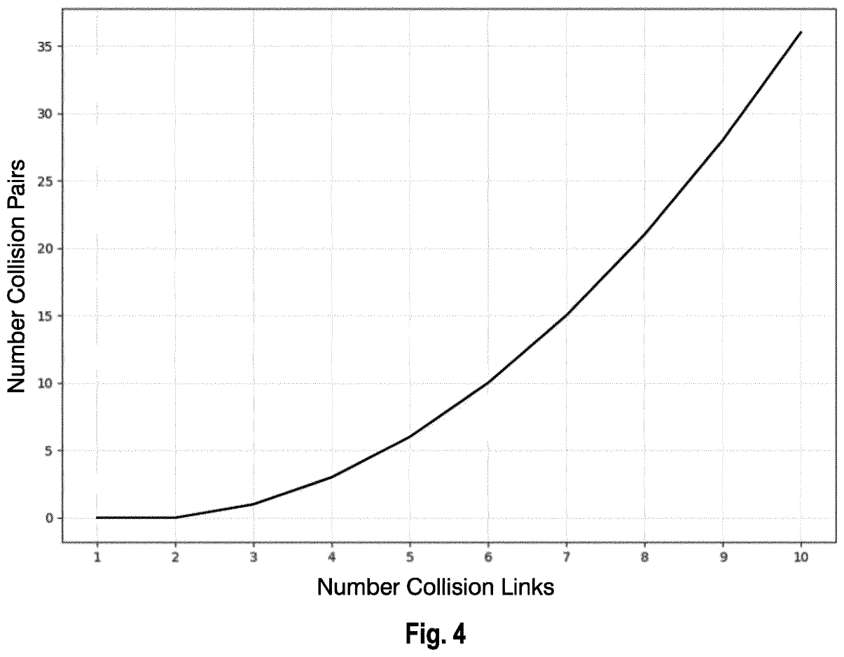

FIG. 4 illustrates in an influence of the number of collision links n_{L} on the number of collision pairs n_{P} as a graph in which the abscissa indicates the number of collision links n_{L} and the ordinate indicates the number of collision pairs n_{P}.

Referring again to FIG. 2, comparing Eq. 4 with the optimization problem according to Eq. 1 provides, for the self-collision avoidance, the following mathematical expression:

$${G}_{sc} = - \frac{δ d}{δ q} Δ t \qquad ( Eq . 5 )$$

$${h}_{sc} = \frac{1}{{k}_{sc}} ( d - {d}_{safety} ) .$$

This constraint may provide feasible self-collision avoidance. However, in order to minimize bouncy maneuvers of the kinematic structure 200, an optional cost function may be utilized according to the following mathematical expression:

$$\begin{matrix}min \\ \dot{q}\end{matrix} - {w}_{sc} \frac{1}{d} \frac{δ d}{δ q} \frac{δ q}{δ t} , \qquad ( Eq . 6 )$$

with w_{sc} denoting a weight of the self-collision avoidance cost function. Eq. 6 is based on the logarithm of the distance. Thereby, to create a dependency on the joint angle velocity, the time derivative of the logarithm is utilized.

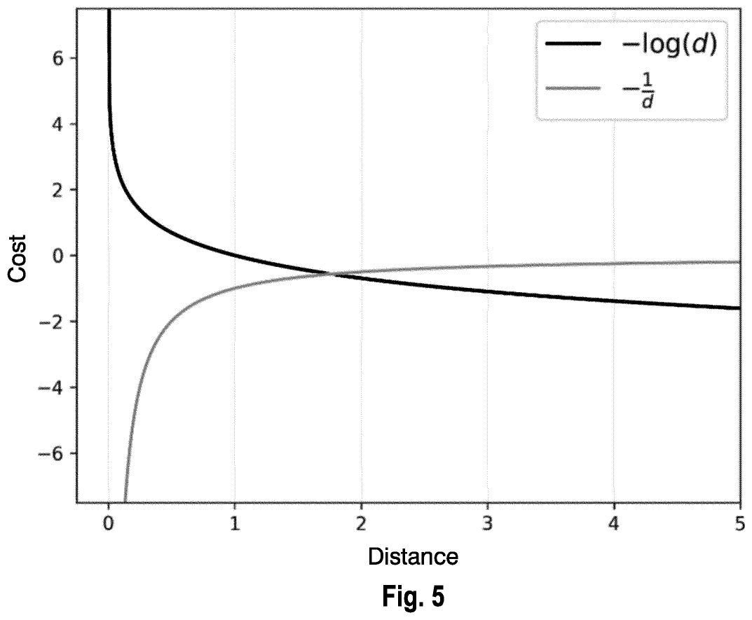

Referring to FIG. 5, which illustrates the collision avoidance cost function as a graph in which the abscissa indicates a distance and the ordinate indicates the cost, it is noted that configurations with small distances incur exponentially increasing costs while configurations with high distances produce similarly small costs. The cost function according to Eq. 6 penalizes closeness and/or incentives the kinematic structure 200 to not move close to the boundary defined by the constraint in Eq. 4, leading to potentially smoother collision avoidance maneuvers.

Referring again to FIG. 2, in at least some examples, the cost function Eq. 6 may be incorporated into the optimization process according to the following mathematical expression:

$${q}_{sc}^{T} = - {w}_{sc} \frac{1}{d} \frac{δ d}{δ q} , \qquad ( Eq . 7 )$$

by which the gradient of the distances with respect to the joint angles may be determined. At least some embodiments, however, may utilize a more efficient way for determining the gradient according to the following mathematical expression:

$$\frac{δ d}{δ q} = - \frac{1}{a} {( {P}_{1} - {P}_{2} )}^{T} ( {J}_{{P}_{1}} - {J}_{{P}_{2}} ) , \qquad ( Eq . 8 )$$

with P₁ denoting a first closest point, P₂ denoting a second closest point, J_{P}_{₁} denoting a Jacobian of P₁ and J_{P}_{₂} denoting a Jacobian of P₂. However, it is noted that it is not mandatory to subtract the full Jacobians. Rather, only for those joints i that may cause a relative motion between P₁ and P₂, i.e., for those joints that lie between P₁ and P₂ in the kinematic chain, may be considered according to the following mathematical expression, distinguishing a revolute joint j and a prismatic joint j:

$$revolute joint : {j}_{{P}_{1 , i}} - {j}_{{P}_{1 , i}} = - \vec{{θ}_{ι}} \times ( \vec{{r}_{{P}_{2}}} - \vec{{r}_{{θ}_{ι}}} ) \qquad ( Eq . 9 )$$

$$prismatic joint : {j}_{{P}_{1 , i}} - {j}_{{P}_{1 , i}} = - \vec{{θ}_{ι}} ,$$

with j_{P}_{_{1,i}}−j_{P}_{_{1,i}}, denoting an entry i of difference J_{P}_{₁} J_{P}_{₂}, \vec{θₗ} an axis of motion of joint \vec{i_{P}_{₂}} denoting a position vector to P₂ and \vec{r_{θ}_{ₗ}} denoting a position vector to joint i. By optionally utilizing Eq. 9, determining of the distance gradient may be reduced to only one cross product for revolute joints between P₁ and P₂, which can even be omitted in case of a prismatic joint since this information may be directly derived from forward kinematics, for which the processing circuitry 120 may also be configured.

The feasibility scalar k_{sc} may be determined in several ways. For example, the feasibility scalar k_{sc} and/or a constant, minimum value of the feasibility scalar k_{sc} may be determined according to the following mathematical expression:

$$\frac{a}{{( {k}_{sc} Δ t )}^{2}} \leq \frac{δ d}{δ q} {\ddot{q}}_{lim} , \qquad ( Eq . 10 )$$

with \ddot{q}ₗᵢₘ denoting a joint acceleration limit (min/max). Thereby, worst case scenarios of Eq. 10 may be determined. Eq. 10 depends on the geometry, expressed by d, the joint acceleration limit(s), expressed by

$$\frac{δ d}{δ q} {\ddot{q}}_{lim}$$

and the update interval Δt. It is noted that Eq. 4 may alternatively be determined in real time by inputting a current value of distance d and

$$\frac{δ d}{δ q} .$$

Alternatively or additionally to Eq. 10, a value of the feasibility scalar k_{sc} may be determined without determining the geometric relationship in Eq. 10. For example, the value of the feasibility scalar k_{sc} may be determined according to the following mathematical expression:

$${k}_{sc} \geq ceil ( maximum ( \frac{{\dot{q}}_{max}}{\vert {\ddot{q}}_{min} \vert Δ t} , \frac{\vert {\dot{q}}_{min} \vert}{{\ddot{q}}_{max} Δ t} ) ) , \qquad ( Eq . 11 )$$

with \dot{q}ₘᵢₙ denoting a minimum joint velocity, \dot{q}ₘₐₓ denoting a maximum joint velocity, \ddot{q}ₘᵢₙ denoting a minimum joint acceleration, \ddot{q}ₘₐₓ denoting a maximum joint acceleration, maximum ( ) denoting an operation that determines the maximum value among a given set of values and ceil ( ) denoting an operation that rounds ab any floating point number to the next integer. Eq. 11 considers the highest possible rate of change at which the shortest distance might be reduced. If the feasibility scalar k_{sc} is determined according to Eq. 11, joint velocity \dot{q} may be determined to avoid self-collision, wherein its execution is actually feasible for the kinematic structure 200.

It is noted that the feasibility scalar k_{sc} determined according to Eq. 11 is constant which may result in a motion of the kinematic structure 200 that is, in at least certain situations or scenarios, more conservative than needed as it is evaluated for worst case scenarios. Therefore, in at least some examples, the feasibility scalar k_{sc} may be determined, e.g., computed, online by utilizing the actual joint velocity \dot{q} instead of global worst-case scenarios \dot{q}ₘₐₓ and/or \dot{q}ₘᵢₙ. For example, an alternative way to determine the feasibility scalar k_{sc} may utilize the following mathematical expression:

$${k}_{sc} ( t ) \geq ceil ( maximum ( \frac{\vert \dot{q} ( t ) \vert}{\vert {\ddot{q}}_{max / min} \vert Δ t} ) , \qquad ( Eq . 12 )$$

with \dot{q}(t) denoting a current joint velocity. Depending on whether \dot{q}(t) has a positive or negative value, \ddot{q}ₘᵢₙ or \ddot{q}ₘₐₓ may be chosen. Thereby, determining the feasibility scalar k_{sc} according to Eq. 12 defines a self-collision avoidance boundary that exerts maximum joint acceleration \ddot{q}ₘᵢₙ or \ddot{q}ₘₐₓ along the entire boundary so as to exhibit a most agile collision avoidance behavior.

Another alternative way to determine the feasibility scalar k_{sc} may be empirically in simulation.

FIG. 3 illustrates an exemplary kinematic structure 200 formed as a robotic device, which may be controlled at least partly by the above apparatus 100. In FIG. 3, arrows indicate three link-obstacle combinations oc1, oc2 and oc3 with respect to an exemplary obstacle 300 present in the environment of the kinematic structure 200, on the basis of which an example of obstacle-collision avoidance for the kinematic structure 200 will be explained in the following. Each of the link-obstacle combinations oc1, oc2 and oc3 relates to a collision path between the respective link 220, 230 and 240 and the obstacle 300. It is noted that the obstacle-collision avoidance may be performed with respect to one or more stationary and/or dynamic obstacles 300. It is further noted that the processing circuitry 120 may be configured, in the optimization process, to find one or more kinematic chain parameters for an obstacle-collision-free state, which may be comprised by the collision-free state to be determined for the kinematic structure 200. In at least some examples, the collision-free state of the kinematic structure 200 to be determined may comprise self-collision and/or joint-collision avoidance, and/or obstacle-collision avoidance.

In general, the processing circuitry 120 is configured, in the optimization process, to penalize closeness of the kinematic chain of the kinematic structure 200 to obtain optimized one or more kinematic chain parameters. For example, this may be expressed by the following mathematical expressions:

$$\begin{matrix}min \\ \dot{q}\end{matrix} - {w}_{oc} \frac{1}{d} \frac{δ d}{δ q} \frac{δ q}{δ t} \qquad ( Eq . 13 )$$

$${q}_{oc}^{T} = - {w}_{oc} \frac{1}{d} \frac{δ d}{δ q} , \qquad ( Eq . 14 )$$

with w_{oc} denoting a weight of the obstacle-collision avoidance cost function. It is noted that Eq. 13 and Eq. 14 regarding obstacle-collision avoidance at least largely correspond to Eq. 6 and Eq. 7 above regarding self-collision avoidance, and a repetition of that description is omitted here.

As above for self-collision avoidance, the optimization problem for obstacle-collision avoidance may comprise one or more constraints according to the following mathematical expressions:

$$\frac{1}{{k}_{oc}} ( d - {d}_{safety} ) + \frac{δ {d}_{o}}{δ q} Δ t \geq - \frac{δ d}{δ q} Δ t \dot{q} \qquad ( Eq . 15 )$$

$${G}_{oc} = - \frac{δ d}{δ q} Δ t \qquad ( Eq . 16 )$$

$${h}_{oc} = \frac{1}{{k}_{oc}} ( d - {d}_{safety} ) + \frac{δ {d}_{o}}{δ q} \qquad ( Eq . 17 )$$

with dₒ denoting a current distance to the obstacle 300 and k_{oc} a feasibility scalar for obstacle-collision. These one or more constraints at least largely correspond to the constraints for self-collision according to Eq. 4 and 5 above. Therefore, reference is made to the above description regarding self-collision and a repetition of that description is omitted here.

It is noted that obstacle-collision avoidance differs from self-collision avoidance, for example, in that the position P and velocity v of an obstacle, i.e., the obstacle 300, cannot be influenced by the kinematic structure 200 itself, e.g., by its joint angles etc. Further, it is noted that when collision is to be avoided with an obstacle, e.g., obstacle 300 in FIG. 3, the constraint Eq. 15, and optionally the cost function Eq. 13, is to be added to the optimization problem of the optimization process for a number of, also every, link-obstacle pair oc1, oc2 and oc3 between the kinematic structure 200 and the obstacle 300 except for the static base link. Only those collisions influenced by the joint angles of the kinematic structure 200 can possibly be avoided by the motion of the kinematic structure 200. This, however, does not necessarily apply to the static base link of the kinematic structure 200 such that it does not need to be considered. Therefore, the number of collision pairs n_{P} may be determined, for example, by the mathematical expression n_{P}=n_{L}−1, with n_{L} denoting the number of links.

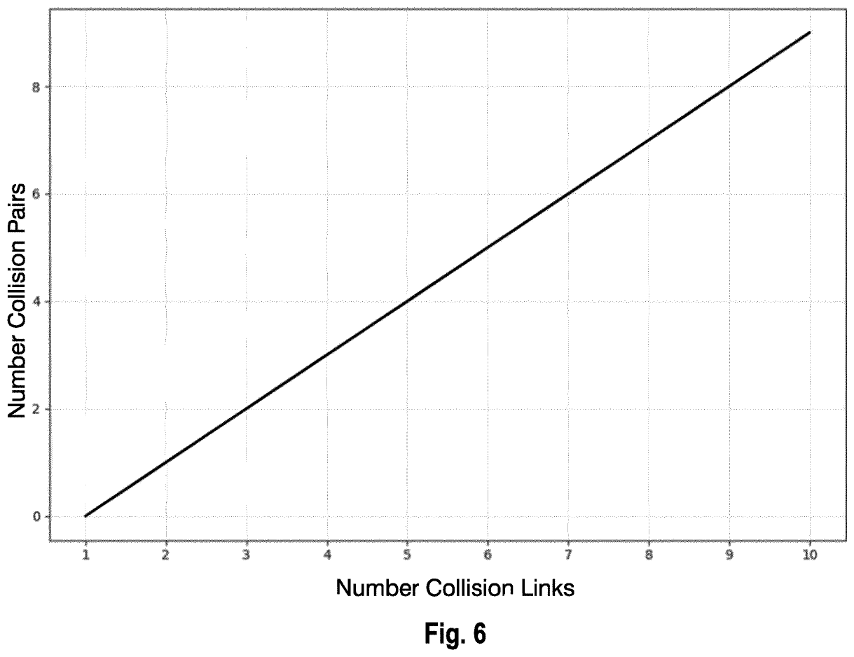

FIG. 6 illustrates the influence of the number of collision links n_{L} on the number of collision pairs n_{P} for obstacle-collision avoidance as a graph in which the abscissa indicates the number of collision links n_{L} and the ordinate indicates the number of collision pairs n_{P}. Accordingly, for the example illustrated in FIG. 3, for obstacle-collision avoidance, three constraints, and optionally cost functions, are to be added to the optimization problem of the optimization process to be performed by the processing circuitry 120.

Referring again to FIG. 3, due to the foregoing description, the gradient of the distance with respect to joint angles has only one Jacobian entry, namely for the closest point of the kinematic structure 200, which may be expressed according to the following mathematical expressions:

$$\frac{δ d}{δ q} = \frac{1}{d} {( {P}_{r} - {P}_{o} )}^{T} {J}_{{P}_{r}} \qquad ( Eq . 18 )$$

$$\frac{δ {d}_{o}}{δ t} = \frac{1}{d} {( {P}_{r} - {P}_{o} )}^{T} {v}_{{P}_{o}} , \qquad ( Eq . 19 )$$

with Pᵣ denoting a closest point on the kinematic structure 200, Pₒ denoting a closest point on the obstacle, J_{P}_{ᵣ} denoting a Jacobian of Pᵣ and v_{P}_{ₒ} a velocity vector of Pₒ on the obstacle, e.g. obstacle 300 in FIG. 3. It is noted that information data regarding the obstacle, e.g., the obstacle 300, may be received by the processing circuitry 120, via the interface circuitry 110, from any suitable data source, such as one or more sensors, or the like, configured to indicate a current state of the kinematic structure 200 and/or a current state of the obstacle 300. Based on such information, the processing circuitry 120 may be configured to determine Pₒ, v_{pO}, etc. Further, it is noted that the forgoing example may allow collision avoidance with regard to both static and dynamic, e.g., moving, obstacles present in the environment of the kinematic structure 200.

For determining the feasibility scalar k_{oc} for obstacle-collision avoidance, reference is made to the above description regarding determining the feasibility scalar k_{sc} for self-collision avoidance. The feasibility scalar k_{oc} for obstacle-collision avoidance oc may be determined in a similar or same manner and a repetition of that description is omitted here.

Still referring to FIG. 2 and FIG. 3, the optimization process performed by the processing circuitry 120 as described above may be modified or extended in many ways.

For example, the optimization process performed by the processing circuitry 120 may comprise tracking of a last link of the kinematic chain of the kinematic structure 200. In case of a robotic device, such as illustrated in FIGS. 2 and 3, the last link, which is the most distal link from a base of the kinematic structure 200, may also be referred to as an end effector, such as the end effector 240 shown in FIGS. 2 and 3. As explained above, the index t of P₁ and

$${q}_{i}^{T}$$

refers to such last link or end effector tracking, which may be an optional objective and/or constraint in the optimization process to be carry out by the processing circuitry 120. For example, the tracking of the last link or end effector, e.g., end effector 240 in FIGS. 2 and 3, may be implemented according to the following mathematical expression:

$$\begin{matrix}min \\ \dot{q}\end{matrix} \frac{1}{2} {( {\dot{x}}_{d} + {k}_{t} ( {x}_{d} - x ) - J \dot{q} )}^{T} {W}_{T} ( {\dot{x}}_{d} + {k}_{t} ( {x}_{d} - x ) - J \dot{q} ) , \qquad ( Eq . 20 )$$

with \dot{x}_{d} denoting a desired last link or end effector velocity, kₜ denoting a proportional gain, x_{d} denoting a desired last link or end effector pose, x denoting an actual last link or end effector pose, J denoting a last link or end effector Jacobian and W_{T} denoting a weight matrix. Eq. 20 represents a quadratic cost function for an error function which is to be minimized, allowing precise last link or end effector tracking without prohibiting a path deviation required for collision avoidance. In other words, this cost function includes the error of the last link or end effector velocity and integrates the error of the last link or end effector position by translating it into a correction velocity via the proportional gain kₜ>0. In yet other words, the tracking of the last link comprises penalizing a deviation from one or more of a desired last link velocity and a desired last link or end effector pose.

In at least some examples, this expression may be expanded, all terms with a dependency on the joint velocity may be isolated and compared to the above Eq. 1 to yield two cost function terms for the objective of last link or end effector tracking according to the following mathematical expressions:

$${P}_{T} = {J}^{T} {W}_{T} J \qquad ( Eq . 21 )$$

$${q}_{t}^{T} = - {( {\dot{x}}_{d} + {k}_{t} ( {x}_{d} - x ) - J \dot{q} )}^{T} {W}_{T} J . \qquad ( Eq . 22 )$$

Eq. 21 minimizes the magnitude of \dot{q}. Eq. 22 maximizes the scalar product between the desired velocity \dot{x}_{d}+kₜ(x_{d}−x) and the real velocity J\dot{q}. The maximum value would attain for infinitely high values for \dot{q}, which may result in an undesired behavior of the kinematic structure 200. A joint optimization of both terms may provide the desired behavior of minimizing the last link or end effector tracking error.

In a further example, the optimization process performed by the processing circuitry 120 may consider hardware limitations which are inherent to the kinematic structure 200. For example, in case of a robotic device, such as illustrated in FIGS. 2 and 3, the kinematic structure 200 may have hardware limitations, including, for example, one or more of a joint angle limit, a joint position limit, a joint velocity limit and a joint acceleration limit, or the like. Therefore, the optimization process may optionally consider feasibility, while still providing self-collision avoidance and/or obstacle-collision avoidance.

The hardware limitations may be complied with by, for example, making use of upper and lower bounds for the joint velocities in the optimization process. It is noted that, as explained above, with respect to the indices of Pᵢ and

$${q}_{t}^{T}$$

acc refers to acceleration and j refers to joint limit, which may be an optional objective and/or constraint in the optimization process.

By way of example, the joint angle limits and joint acceleration limits may be first converted into joint velocities according to the following mathematical expressions:

$${x}_{min} = {\dot{q}}_{bound -} = maximum ( {\dot{q}}_{min , acc} , {\dot{q}}_{min ,} {\dot{q}}_{min , pos} ) \qquad ( Eq . 23 )$$

$${x}_{max} = {\dot{q}}_{bound +} = minimum ( {\dot{q}}_{max , acc} , {\dot{q}}_{max ,} {\dot{q}}_{max , pos} ) \qquad ( Eq . 24 )$$

$${\dot{q}}_{max , pos} = \frac{{q}_{max} - q}{{k}_{j , 1} Δ t} \qquad ( Eq . 25 )$$

$${\dot{q}}_{min , pos} = \frac{{q}_{min} - q}{{k}_{j , 2} Δ t} \qquad ( Eq . 26 )$$

$${\dot{q}}_{max , acc} = \frac{1}{3} ( 2 Δ t {\ddot{q}}_{max} + 4 \dot{q} ( t - Δ t ) + \dot{q} ( t - 2 Δ t ) ) \qquad ( Eq . 27 )$$

$${\dot{q}}_{min , acc} = \frac{1}{3} ( 2 Δ t {\ddot{q}}_{min} + 4 \dot{q} ( t - Δ t ) + \dot{q} ( t - 2 Δ t ) ) \qquad ( Eq . 28 )$$

with \dot{q}_{bound-} denoting a lower bound for the joint velocity in the optimization process, \dot{q}_{bound+} denoting an upper bound for the joint velocity in the optimization process, \dot{q}_{min,acc} denoting a lower bound joint velocity resulting from joint acceleration constraints, \dot{q}ₘᵢₙ denoting an actual lower bound joint velocity, \dot{q}_{min,pos} denoting a lower bound joint velocity resulting from joint angle limits, \dot{q}_{max,acc} denoting an upper bound joint velocity resulting from joint acceleration constraints, \dot{q}ₘₐₓ denoting an actual upper bound joint velocity, \dot{q}_{max,pos} denoting an upper bound joint velocity resulting from joint angle limits, k_{j,1} denoting a feasibility scalar for the upper joint angle limit, k_{j,2} denoting a feasibility scalar for the lower joint angle limit, \dot{q}(t−Δt) denoting a joint velocity one update interval prior and \dot{q}(t−2Δt) denoting a joint velocity two update intervals prior.

Basically, the joint angle limit may be handled at least similarly to the collision constraint as described above. Instead of the distance between the bodies, the remaining joint travel in each direction may be determined and by means of the update interval Δt translated into an admissible joint velocity, for example, according to the following mathematical expressions:

$$\frac{1}{{k}_{j , 1}} ( {q}_{max} - q ) \geq \dot{q} Δ t \to {\dot{q}}_{max , pos} = \frac{{q}_{max} - q}{{k}_{j , 1} Δ t} \qquad ( Eq . 29 )$$

$$\frac{1}{{k}_{j , 2}} ( {q}_{min} - q ) \leq \dot{q} Δ t \to {\dot{q}}_{min , pos} = \frac{{q}_{min} - q}{{k}_{j , 2} Δ t}$$

The feasibility scalar kⱼ has a similar or the same meaning as described above for the collision avoidance and may, for example, determined according to the following mathematical expression:

$${k}_{j , 1} \geq ceil ( \frac{{\dot{q}}_{max}}{\vert {\ddot{q}}_{min} \vert Δ t} ) \qquad ( Eq . 30 )$$

$${k}_{j , 2} \geq ceil ( \frac{\vert {\dot{q}}_{min} \vert}{{\dot{q}}_{max} Δ t} ) .$$

Alternatively and following the same reasoning as described above with respect to Eq. 12, the feasibility scalar kⱼ may also be determined according to the following mathematical expressions:

$${k}_{j , 1} ( t ) \geq ceil ( \frac{{\dot{q}}_{max}}{\vert {\ddot{q}}_{min} \vert Δ t} ) \qquad ( Eq . 31 )$$

$${k}_{j , 2} ( t ) \geq ceil ( \frac{\vert {\dot{q}}_{min} \vert}{{\dot{q}}_{max} Δ t} ) .$$

Further, the joint angle acceleration limit may be translated into an admissible joint velocity by applying backwards differentiation with a suitable order to be chosen. For example, for the second order derivative, the translation may be determined according to the following mathematical expression:

$$\ddot{q} ( t ) = \frac{3 \dot{q} ( t ) - 4 \dot{q} ( t - Δ t ) + \dot{q} ( t - 2 Δ t )}{2 Δ t} . \qquad ( Eq . 32 )$$

In addition, the lower and upper acceleration limits may be inserted, the terms may be rearranged, and solved for \dot{q}(t) provides the joint angle velocity limits according to the following mathematical expressions:

$${\dot{q}}_{max , acc} = \frac{1}{3} ( 2 Δ t {\ddot{q}}_{max} + 4 \dot{q} ( t - Δ t ) + \dot{q} ( t - 2 Δ t ) ) \qquad ( Eq . 33 )$$

$${\dot{q}}_{min , acc} = \frac{1}{3} ( 2 Δ t {\ddot{q}}_{min} + 4 \dot{q} ( t - Δ t ) - \dot{q} ( t - 2 Δ t ) ) .$$

It is noted that with two velocities each for the upper and lower boundaries of the joint angle position and joint angle acceleration limit and with the real limits for joint angle velocity, all limit velocities may be compared to each other to determine which one is passed to the optimization problem. For example, the upper and lower boundaries may be determined according to the following mathematical expressions:

$${\dot{q}}_{bound -} = maximum ( {\dot{q}}_{min , acc} , {\dot{q}}_{min ,} {\dot{q}}_{min , pos} ) \qquad ( Eq . 34 )$$

$${\dot{q}}_{bound +} = minimum ( {\dot{q}}_{max , acc} , {\dot{q}}_{max ,} {\dot{q}}_{max , pos} ) .$$

For the lower/upper bound, the max/min velocity of all min/max velocities may be chosen as these are the ones which would be violated first. Passing those to the optimization problem may ensure that all the limits are always respected. Those values are used as the boundary for the optimization variable in the above Eq. 23 and Eq. 24.

The same procedure may also be carried out for a jerk to account for limitations in the actuator's dynamics. Instead of taking the first derivative as shown for the acceleration in Eq. 32, the second backwards derivative of the joint angle velocity may be determined.

In a further example, the optimization process performed by the processing circuitry 120 may consider motion smoothness for controlling the kinematic structure 200. For example, motion smoothness may refer to control the motion of the links 210, 220, 230 and 240 of the kinematic structure according to FIGS. 2 and 3 to be smooth, while still providing self-collision avoidance and/or joint collision avoidance and/or obstacle-collision avoidance. Therefore, in at least some examples, it may be desirable for the optimization process to penalize high acceleration values and/or to incentivize smooth motion, according to the following mathematical expression:

$$\begin{matrix}min \\ \dot{q}\end{matrix} \frac{1}{2} {\ddot{q}}^{T} {W}_{acc} \ddot{q} \qquad ( Eq . 35 )$$

$$with \ddot{q} = \frac{1}{2 Δ t} ( 3 \dot{q} ( t ) + 4 \dot{q} ( t - Δ t ) + \dot{q} ( t - 2 Δ t ) ,$$

with W_{acc} denoting a weight matrix for motion smoothness and \dot{q}(t) denoting a current joint velocity. This expression may be expanded to provide, for example, two cost terms, which may filter out potential spikes in the acceleration of joints, according to the following mathematical expressions:

$${P}_{acc} = \frac{9}{4 Δ {t}^{2}} {W}_{acc} \qquad ( Eq . 36 )$$

$${q}_{acc}^{T} = \frac{1}{4 Δ {t}^{2}} ( - 12 {\dot{q} ( t - Δ t )}^{T} + 3 {\dot{q} ( t - 2 Δ t )}^{T} ) {W}_{acc} .$$

As explained above, the index acc of Pᵢ and

$${q}_{i}^{T}$$

refers to such motion smoothness. It is noted that motion smoothness is not mandatory for self-collision avoidance and/or obstacle-collision avoidance but may be optionally considered in the optimization process performed by the processing circuitry 200.

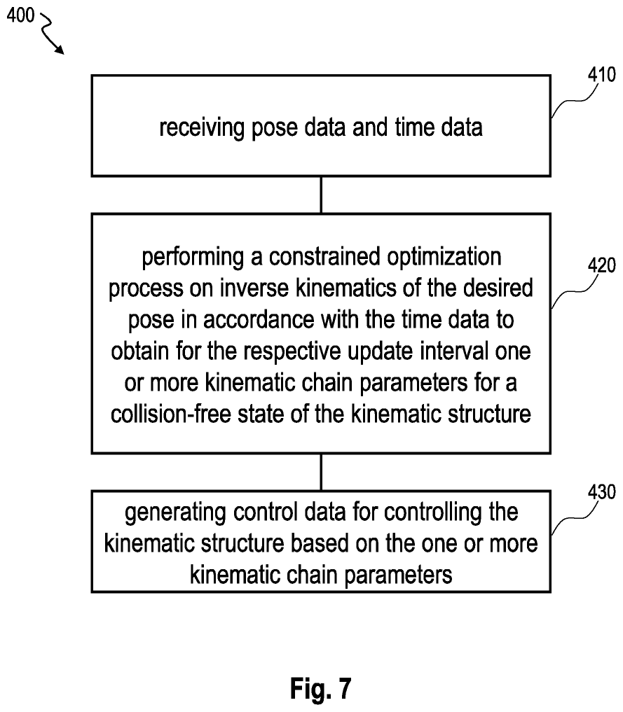

For further highlighting the collision avoidance described above, FIG. 7 illustrates in a flowchart a method 400 of collision avoidance for a kinematic structure. The method comprises receiving 410 pose data indicating a desired pose for the kinematic structure and time data indicating an update interval used to control the kinematic structure. Further, the method comprises performing 420 a constrained optimization process on inverse kinematics of the desired pose in accordance with the time data to obtain for the respective update interval one or more kinematic chain parameters for or associated with a collision-free state of the kinematic structure. In addition, the method comprises generating 430 control data for controlling the kinematic structure based on the one or more kinematic chain parameters.

The method 400 may allow, by coupling the optimization-based inverse kinematics to the update interval indicated by the time data to carry out its full computation at each update interval, the kinematic structure to be controlled under collision avoidance for even dynamic tasks and/or in unstructured and unpredictable environments, e.g., with one or more dynamic obstacles. Performing the constrained optimization process may require only little computational effort. Further, by performing the constrained optimization process on the inverse kinematics of the desired pose, the kinematic structure may be controlled, based on the resulting one or more kinematic chain parameters, to operate at its limit considering feasibility.

More details and aspects of the method 400 are explained in connection with the proposed technique or one or more examples described above (e.g., FIG. 1 to FIG. 3). The method 400 may comprise one or more additional optional features corresponding to one or more aspects of the proposed technique or one or more examples described above.

The following examples pertain to further embodiments:
(1) A method of collision avoidance for a kinematic structure, comprising:
receiving pose data indicating a desired pose for the kinematic structure and time data indicating an update interval used to control the kinematic structure;
performing a constrained optimization process on inverse kinematics of the desired pose in accordance with the time data to obtain for the respective update interval one or more kinematic chain parameters for a collision-free state of the kinematic structure; and generating control data for controlling the kinematic structure based on the one or more kinematic chain parameters.
(2) The method of (1), wherein the optimization process utilizes one or more constraints separating an admissible, collision-free space of the kinematic structure from a non-collision-free, forbidden space of the kinematic structure.
(3) The method of (1) or (2), wherein the optimization process comprises solving a number of objectives for one or more of self-collision avoidance, joint-collision avoidance and obstacle-collision avoidance to obtain optimized one or more kinematic chain parameters.
(4) The method of (3), wherein the optimization process utilizes a number of cost functions and/or constraints to solve the number of objectives.
(5) The method of any one of (1) to (4), wherein the optimization process comprises penalizing determining such kinematic chain parameters and/or states of the kinematic structure that do not violate one or more constraints for the collision-free state to obtain optimized one or more kinematic chain parameters.
(6) The method of any one of (1) to (5), wherein the optimization process comprises penalizing closeness of elements within a kinematic chain of the kinematic structure to each other to obtain optimized one or more kinematic chain parameters.
(7) The method of (6), wherein penalizing closeness comprises restricting a maximum value that a shortest distance between the elements within the kinematic chain is allowed to change within the respective update interval to obtain optimized one or more kinematic chain parameters.
(8) The method of any one of (1) to (7), wherein the optimization process comprises penalizing closeness of the kinematic structure to an obstacle to obtain optimized one or more kinematic chain parameters.
(9) The method of (8), wherein penalizing closeness comprises restricting a maximum value that a shortest distance between the kinematic structure to the obstacle is allowed to change within the respective update interval while considering one or more of a motion and a direction of the obstacle.
(10) The method of any one of (1) to (9), wherein the optimization process comprises penalizing such kinematic chain parameters and/or states of the kinematic structure that violate one or more constraints for hardware limitations of the kinematic structure to obtain optimized one or more kinematic chain parameters.
(11) The method of (10), wherein the one or more constraints for hardware limitations comprises one or more of a joint angle limit, a joint position limit, a joint velocity limit and a joint acceleration limit.
(12) The method of any one of (1) to (11), wherein the optimization process comprises penalizing such kinematic chain parameters and/or states of the kinematic structure that violate one or more constraints for with acceleration limits of the kinematic chain of the kinematic structure to obtain optimized one or more kinematic chain parameters.
(13) The method of (12), wherein the optimization process comprises limiting acceleration of one or more elements within the kinematic chain of the kinematic structure.
(14) The method of any one of (1) to (13), wherein the optimization process comprises tracking of a last link of the kinematic chain of the kinematic structure.
(15) The method of (14), wherein the tracking of the last link comprises penalizing a deviation from one or more of a desired last link velocity and a desired last link pose.
(16) The method of any one of (1) to (15), wherein the method utilizes quadratic programming to obtain, for the respective update interval, the one or more kinematic chain parameters.
(17) The method of any one of (1) to (16), wherein the kinematic structure is a robotic device or a part thereof.
(18) The method of any one of (1) to (16), wherein the kinematic structure is a computer animated object.
(19) An apparatus for controlling a kinematic structure, comprising:
interface circuitry configured to receive pose data indicating a desired pose for the kinematic structure and time data indicating an update interval used to control the kinematic structure; and
processing circuitry configured to:
perform a constrained optimization process on inverse kinematics of the desired pose in accordance with the time data to obtain for the respective update interval one or more kinematic chain parameters for a collision-free state of the kinematic structure; and
generate control data for controlling the kinematic structure based on the one or more kinematic chain parameters.
(20). The apparatus of (19), wherein the processing circuitry is configured to run an inverse kinematics solver to output the one or more kinematic chain parameter for the respective update interval.
(21) A system, comprising:
an apparatus according to any one of (19) and (20); and
a robotic device configured to operate based on the control data.
(22) A non-transitory machine-readable medium having stored thereon a program having a program code for performing the method according to any one of (1) to (18), when the program is executed on a processor or a programmable hardware.
(23) A program having a program code for performing the method according to any one of (1) to (18), when the program is executed on a processor or a programmable hardware.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (F)PGA), graphics processor units (GPU), ASICs, integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A method of collision avoidance for a kinematic structure, comprising:
receiving pose data indicating a desired pose for the kinematic structure and time data indicating an update interval used to control the kinematic structure;
performing a constrained optimization process on inverse kinematics of the desired pose in accordance with the time data to obtain for the respective update interval one or more kinematic chain parameters for a collision-free state of the kinematic structure; and
generating control data for controlling the kinematic structure based on the one or more kinematic chain parameters.

2. The method of claim 1, wherein the optimization process utilizes one or more constraints separating an admissible, collision-free space of the kinematic structure from a non-collision-free, forbidden space of the kinematic structure.

3. The method of claim 1, wherein the optimization process comprises solving a number of objectives for one or more of self-collision avoidance, joint-collision avoidance and obstacle-collision avoidance to obtain optimized one or more kinematic chain parameters.

4. The method of claim 3, wherein the optimization process utilizes a number of cost functions and/or constraints to solve the number of objectives.

5. The method of claim 1, wherein the optimization process comprises determining such kinematic chain parameters and/or states of the kinematic structure that do not violate one or more constraints for the collision-free state to obtain optimized one or more kinematic chain parameters.

6. The method of claim 1, wherein the optimization process comprises penalizing closeness of elements within a kinematic chain of the kinematic structure to each other to obtain optimized one or more kinematic chain parameters.

7. The method of claim 1, wherein the optimization process comprises penalizing closeness of the kinematic structure to an obstacle to obtain optimized one or more kinematic chain parameters.

8. The method of claim 1, wherein the optimization process comprises penalizing such kinematic chain parameters and/or states of the kinematic structure that violate one or more constraints for hardware limitations of the kinematic structure to obtain optimized one or more kinematic chain parameters.

9. The method of claim 8, wherein the one or more constraints for hardware limitations comprises one or more of a joint angle limit, a joint position limit, a joint velocity limit and a joint acceleration limit.

10. The method of claim 1, wherein the optimization process comprises penalizing such kinematic chain parameters and/or states of the kinematic structure that violate one or more constraints for acceleration limits of the kinematic chain of the kinematic structure to obtain optimized one or more kinematic chain parameters.

11. The method of claim 10, wherein the optimization process comprises limiting acceleration of one or more elements within the kinematic chain of the kinematic structure.

12. The method of claim 1, wherein the optimization process comprises tracking of a last link of the kinematic chain of the kinematic structure.

13. The method of claim 12, wherein the tracking of the last link comprises penalizing a deviation from one or more of a desired last link velocity and a desired last link pose.

14. The method of claim 1, wherein the method utilizes quadratic programming to obtain, for the respective update interval, the one or more kinematic chain parameters.

15. The method of claim 1, wherein the kinematic structure is a robotic device or a part thereof.

16. An apparatus for controlling a kinematic structure, comprising:
interface circuitry configured to receive pose data indicating a desired pose for the kinematic structure and time data indicating an update interval used to control the kinematic structure;
and
processing circuitry configured to:
perform a constrained optimization process on inverse kinematics of the desired pose in accordance with the time data to obtain for the respective update interval one or more kinematic chain parameters for a collision-free state of the kinematic structure; and
generate control data for controlling the kinematic structure based on the one or more kinematic chain parameters.

17. The apparatus of claim 16, wherein the processing circuitry is configured to run an inverse kinematics solver to output the one or more kinematic chain parameter for the respective update interval.

18. A system, comprising:
an apparatus according to claim 16; and
a robotic device configured to operate based on the control data.

19. A non-transitory machine-readable medium having stored thereon a program having a program code for performing the method according to claim 1, when the program is executed on a processor or a programmable hardware.

20. (canceled)
